(19) United States
(12) Patent Application Publication
(10) Pub. No.: US 2024/0217060 A1
(43) Pub. Date: Jul. 4, 2024

(54) SUBSTRATE POLISHING DEVICE, SUBSTRATE PROCESSING APPARATUS, METHOD, AND STORAGE MEDIUM

(71) Applicant: EBARA CORPORATION, Tokyo (JP)

(72) Inventors: Masashi KABASAWA, Tokyo (JP); Keita YAGI, Tokyo (JP); Yoichi SHIOKAWA, Tokyo (JP); Toshimitsu SASAKI, Tokyo (JP); Kohei EGAWA, Tokyo (JP)

(21) Appl. No.: 18/395,191

(22) Filed: Dec. 22, 2023

(30) Foreign Application Priority Data
Dec. 28, 2022 (JP) 2022-211159

(51) Int. Cl. B24B 49/03; B24B 49/04

(52) U.S. Cl. CPC B24B 49/03; B24B 49/04

(57) ABSTRACT

A substrate polishing device includes a height detection unit configured to measure a surface height of a polishing member, and a cutting rate calculation unit configured to calculate a cutting rate of the polishing member based on the surface height. The cutting rate calculation unit corrects the current cutting rate based on the cutting rate calculated in the past when the calculated current cutting rate falls outside a search range.

### CROSS-REFERENCE TO RELATED APPLICATION

The present application claims the priority of Japanese Patent Application No. 2022-211159 filed on Dec. 28, 2022, the contents of which are entirely incorporated by reference.

### BACKGROUND

### Field of the Disclosure

The present disclosure relates to a substrate polishing device, a substrate processing apparatus, a method, and a storage medium.

### Description of the Related Art

As semiconductor devices becomes more highly integrated, the wiring of circuits is becoming finer, and the dimensions of devices to be integrated are also becoming smaller. Therefore, a step of polishing a wafer in which a film of metal or the like is formed on the surface of the wafer to flatten the surface of the wafer is required. As one of the flattening methods, there is polishing by a chemical mechanical polishing (CMP) device. The chemical mechanical polishing device includes a polishing member (polishing cloth, polishing pad, and the like) and a holding unit (top ring, polishing head, chuck, and the like) configured to hold a polishing target such as a wafer. The surface of the polishing target (surface to be polished) is pressed against the surface of the polishing member, and the polishing member and the polishing target are relatively moved while a polishing liquid (abrasive liquid, chemical liquid, slurry, pure water, and the like) is supplied between the polishing member and the polishing target. In this manner, the surface of the polishing target is polished to be flat.

As a material of the polishing member used in such a chemical mechanical polishing device, a foamed resin or a nonwoven fabric is generally used. Fine irregularities are formed on the surface of the polishing member, and the fine irregularities act as a chip pocket effective for preventing clogging and reducing polishing resistance. However, when the polishing target is continuously polished by the polishing member, fine irregularities on the surface of the polishing member are crushed, and the polishing rate for the polishing target is decreased. Therefore, dressing is performed on the surface of the polishing member with a dresser in which a large number of abrasive grains such as diamond grains are electrodeposited, thereby forming fine irregularities on the surface of the polishing member again.

As a dressing method of the polishing member, for example, dressing is performed by pressing a dressing surface against the rotating polishing member while moving (reciprocating or swinging in an arc shape or a linear shape) the rotating dresser. When dressing is performed on the polishing member, the surface of the polishing member is scraped off although the amount is small. Therefore, if the dressing is not appropriately performed, an inappropriate undulation occurs on the surface of the polishing member, and variations in the polishing rate for the polishing target occur. Since the variation in the polishing rate causes a polishing failure, it is necessary to appropriately perform dressing not to cause an inappropriate undulation on the surface of the polishing member. That is, it is necessary to avoid a variation in the cutting rate of the polishing member by performing dressing under appropriate dressing conditions such as an appropriate rotation speed of the polishing member, an appropriate rotation speed of the dresser, an appropriate dressing load, and an appropriate moving speed of the dresser, and to prevent an occurrence of an inappropriate undulation.

However, when the polishing member (polishing pad or the like) absorbs moisture and swells with the elapse of time, the apparent height of the polishing member increases, and thus it is not possible to appropriately calculate the cutting rate of the polishing member.

### CITATION LIST

### Patent Literature

Patent Literature 1: JP 2022-32201 A

### SUMMARY

According to a first aspect, a substrate polishing device includes a height detection unit configured to measure a surface height of a polishing member, and a cutting rate calculation unit configured to calculate a cutting rate of the polishing member based on the surface height. The cutting rate calculation unit corrects the current cutting rate based on the cutting rate calculated in the past when the calculated current cutting rate falls outside a search range.

Further features of the present invention will become apparent from the following description of exemplary embodiments (with reference to the attached drawings).

### BRIEF DESCRIPTION OF THE DRAWINGS

FIG. 1 is a schematic view illustrating a polishing device that polishes a substrate such as a wafer;

FIG. 2 is a plan view schematically illustrating a dresser and a polishing pad;

FIG. 3 is a view illustrating an example of a scanning area set on the polishing pad;

FIG. 4 is an explanatory view illustrating a relationship between the scanning area of the polishing pad and a monitoring area;

FIG. 5 is a block diagram illustrating an example of a configuration of a dresser monitoring device;

FIG. 6 is an explanatory view illustrating an example of profile transition of a polishing pad height in each scanning area;

FIG. 7 is an explanatory view illustrating an example of a dresser moving speed and a reference value in each scanning area;

FIG. 8 is a flowchart illustrating an example of an adjustment procedure of a moving speed of a dresser;

FIG. 9 is a flowchart illustrating an example of a process of updating a cutting rate for calculating a staying time;

FIG. 10 is a flowchart illustrating an example of a cutting rate correction process; and

FIG. 11 is a graph illustrating a relationship between the number of processed wafers and the cutting rate, and is a view for describing correction of the cutting rate.

### DESCRIPTION OF THE EMBODIMENTS

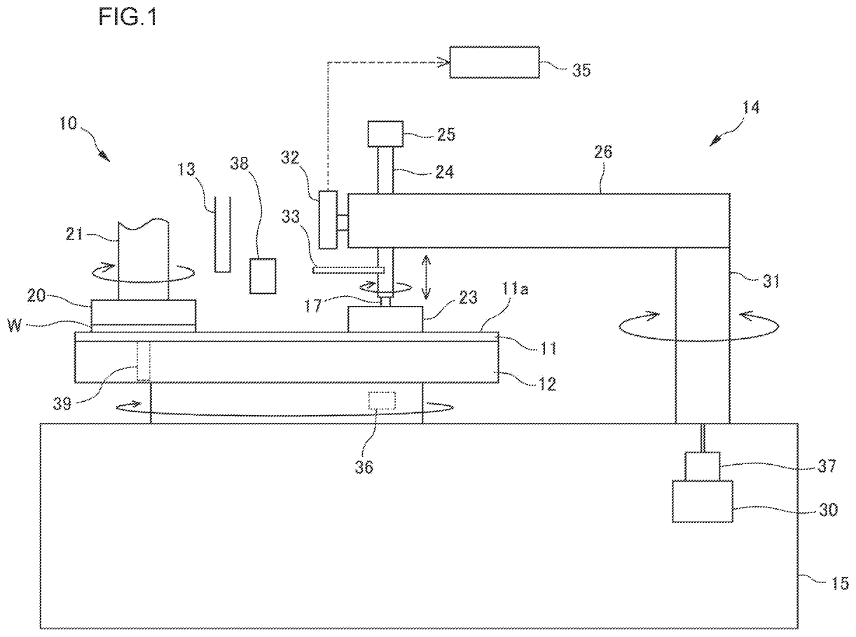

An embodiment of the present invention will be described with reference to the drawings. FIG. 1 is a schematic view illustrating a polishing device that polishes a substrate such as a wafer. The polishing device is provided in a substrate processing apparatus capable of performing a series of steps of polishing, cleaning, and drying a wafer.

As illustrated in FIG. 1, the polishing device includes a polishing unit 10 configured to polish a wafer W, a polishing table 12 for holding a polishing pad (polishing member) 11, a polishing liquid supply nozzle 13 for supplying a polishing liquid onto the polishing pad 11, and a dressing unit 14 configured to perform conditioning (dressing) on the polishing pad 11 used for polishing the wafer W. The polishing unit 10 and the dressing unit 14 are installed on a base 15.

The polishing unit 10 includes a top ring (substrate holder) 20 joined to a lower end of a top ring shaft 21. The top ring 20 is configured to hold the wafer W on the lower surface of the top ring by vacuum suction. The top ring shaft 21 is rotated by driving of a motor (not illustrated), and the top ring 20 and the wafer W are rotated by the rotation of the top ring shaft 21. The top ring shaft 21 is moved up and down with respect to the polishing pad 11 by a vertical movement mechanism (for example, a vertical movement mechanism including a servomotor, a ball screw, and the like) (not illustrated).

The polishing table 12 is joined to a motor 22 disposed below the polishing table. The polishing table 12 is rotated around the axis of the polishing table by the motor 22. The polishing pad 11 adheres to the upper surface of the polishing table 12, and the upper surface of the polishing pad 11 constitutes a polishing surface 11a for polishing the wafer W.

The wafer W is polished as follows. The top ring 20 and the polishing table 12 are rotated to supply a polishing liquid onto the polishing pad 11. In this state, the top ring 20 holding the wafer W is lowered, and the wafer W is pressed against the polishing surface 11a of the polishing pad 11 by a pressurizing mechanism (not illustrated) including an airbag installed in the top ring 20. The wafer W and the polishing pad 11 are brought into sliding contact with each other in the presence of the polishing liquid, thereby polishing and flattening the surface of the wafer W.

The dressing unit 14 includes a dresser 23 that is in contact with the polishing surface 11a of the polishing pad 11, a dresser shaft 24 joined to the dresser 23, an air cylinder 25 provided at an upper end of the dresser shaft 24, and a dresser arm 26 that rotatably supports the dresser shaft 24. Abrasive grains such as diamond grains are fixed to the lower surface of the dresser 23. The lower surface of the dresser 23 constitutes a dressing surface for dressing the polishing pad 11.

The dresser shaft 24 and the dresser 23 are vertically movable with respect to the dresser arm 26. The air cylinder 25 is a device that applies a dressing load on the polishing pad 11 to the dresser 23. The dressing load can be adjusted by the air pressure supplied to the air cylinder 25.

The dresser arm 26 is configured to be driven by a motor 30 to swing around a support shaft 31. The dresser shaft 24 is rotated by a motor (not illustrated) installed in the dresser arm 26, and the dresser 23 is rotated around the axis of the dresser by the rotation of the dresser shaft 24. The air cylinder 25 presses the dresser 23 against the polishing surface 11a of the polishing pad 11 with a predetermined load via the dresser shaft 24.

Conditioning of the polishing surface 11a of the polishing pad 11 is performed as follows. The polishing table 12 and the polishing pad 11 are rotated by a motor 22, and a dressing liquid (for example, pure water) is supplied from a dressing liquid supply nozzle (not illustrated) to the polishing surface 11a of the polishing pad 11. Further, the dresser 23 is rotated around the axis of the dresser 23. The dresser 23 is pressed against the polishing surface 11a by the air cylinder 25, and the lower surface (dressing surface) of the dresser 23 is brought into sliding contact with the polishing surface 11a. In this state, the dresser arm 26 is turned to swing the dresser 23 on the polishing pad 11 in the substantially radial direction of the polishing pad 11. The polishing pad 11 is scraped off by the rotating dresser 23, thereby performing conditioning of the polishing surface 11a.

A pad height sensor (surface height measuring instrument) 32 configured to measure the height of the polishing surface 11a is fixed to the dresser arm 26. A sensor target 33 is fixed to the dresser shaft 24 to face the pad height sensor 32. The sensor target 33 moves up and down integrally with the dresser shaft 24 and the dresser 23, and the position of the pad height sensor 32 in the vertical direction is fixed. The pad height sensor 32 is a displacement sensor, and can indirectly measure the height of the polishing surface 11a (the thickness of the polishing pad 11) by measuring the displacement of the sensor target 33. Since the sensor target 33 is joined to the dresser 23, the pad height sensor 32 can measure the height of the polishing surface 11a during conditioning of the polishing pad 11.

The height of the polishing surface 11a is measured by the pad height sensor 32 in a plurality of predetermined regions (monitoring areas) divided in the radial direction of the polishing pad. The pad height sensor 32 indirectly measures the height of the polishing surface 11a from the position of the dresser 23 in contact with the polishing surface 11a in the vertical direction. Therefore, the average height of the polishing surface 11a in a region (certain monitoring area) that is in contact with the lower surface (dressing surface) of the dresser 23 is measured by the pad height sensor 32, and the height of the polishing pad is measured in a plurality of monitoring areas. In this manner, it is possible to obtain the profile of the polishing pad (cross-sectional shape of the polishing surface 11a). As the pad height sensor 32, any type of sensor such as a linear scale sensor, a laser sensor, an ultrasonic sensor, or an eddy current sensor can be used.

The pad height sensor 32 is connected to a dressing monitoring device 35, and an output signal (that is, the measured value of the height of the polishing surface 11a) of the pad height sensor 32 is transmitted to the dressing monitoring device 35. The dressing monitoring device 35 includes a function of acquiring the profile of the polishing pad 11 from the measured value of the height of the polishing surface 11a and further determining whether or not conditioning of the polishing pad 11 is being performed correctly.

The polishing device includes a table rotary encoder 36 that measures rotation angles of the polishing table 12 and the polishing pad 11, and a dresser rotary encoder 37 that measures a turning angle of the dresser 23. The table rotary encoder 36 and the dresser rotary encoder 37 are absolute encoders that measure absolute values of angles. The rotary encoders 36 and 37 are connected to the dressing monitoring device 35. The dressing monitoring device 35 can acquire the rotation angles of the polishing table 12 and the polishing pad 11, and further the turning angle of the dresser 23 when the height of the polishing surface 11a is measured by the pad height sensor 32.

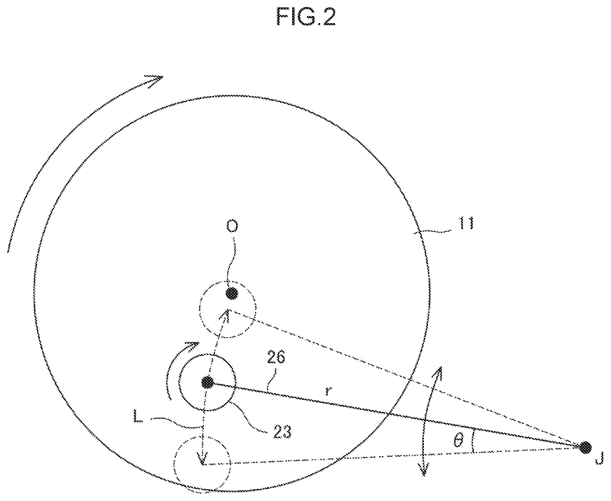

The dresser 23 is joined to the dresser shaft 24 via a universal joint 17. The dresser shaft 24 is joined to a motor (not illustrated). The dresser shaft 24 is rotatably supported by the dresser arm 26, and the dresser arm 26 causes the dresser 23 to swing in the radial direction of the polishing pad 11 as illustrated in FIG. 2 while coming into contact with the polishing pad 11. The universal joint 17 is configured to allow tilting of the dresser 23 and transmit the rotation of the dresser shaft 24 to the dresser 5. The dresser 23, the universal joint 17, the dresser shaft 24, the dresser arm 26, a rotation mechanism (not illustrated), and the like constitute the dressing unit 14. The dressing monitoring device 35 that calculates a sliding distance and a sliding speed of the dresser 23 is electrically connected to the dressing unit 14. As the dressing monitoring device 35, a dedicated or general-purpose computer can be used.

Abrasive grains such as diamond grains are fixed to the lower surface of the dresser 23. The part to which the abrasive grains are fixed constitutes the dressing surface for dressing the polishing surface of the polishing pad 11. As an aspect of the dressing surface, a circular dressing surface (dressing surface in which abrasive grains are fixed to the entire lower surface of the dresser 23), a ring-like dressing surface (dressing surface in which abrasive grains are fixed to the peripheral edge part of the lower surface of the dresser 23), or a plurality of circular dressing surfaces (dressing surface in which abrasive grains are fixed to surfaces of a plurality of small-diameter pellets arranged at substantially equal intervals around the center of the dresser 23) can be applied. The dresser 23 in the present embodiment is provided with a circular dressing surface.

When the polishing pad 11 is dressed, as illustrated in FIG. 1, the polishing pad 11 is rotated at a predetermined rotation speed in a direction of the arrow, and the dresser 23 is rotated at a predetermined rotation speed in a direction of the arrow by a rotation mechanism (not illustrated). In this state, the dressing surface (the surface on which the abrasive grains are arranged) of the dresser 23 is pressed against the polishing pad 11 with a predetermined dressing load. In this manner, dressing of the polishing pad 11 is performed. Since the dresser arm 26 swings the dresser 23 on the polishing pad 11, it is possible to dress a region (polishing region, that is, region for polishing a polishing target such as a wafer) used in polishing of the polishing pad 11.

Since the dresser 23 is joined to the dresser shaft 24 via the universal joint 17, the dressing surface of the dresser 23 appropriately abuts on the polishing pad 11 even if the dresser shaft 24 is slightly inclined with respect to the surface of the polishing pad 11. A pad roughness measuring device 38 that measures the surface roughness of the polishing pad 11 is disposed above the polishing pad 11. As the pad roughness measuring device 38, a known non-contact type surface roughness measuring device such as an optical type surface roughness measuring device can be used. The pad roughness measuring device 38 is connected to the dressing monitoring device 35, and the measured value of the surface roughness of the polishing pad 11 is transmitted to the dressing monitoring device 35.

A film thickness sensor (film thickness measuring instrument) 39 that measures the film thickness of the wafer W is disposed in the polishing table 12. The film thickness sensor 39 is disposed to face the surface of the wafer W held by the top ring 20. The film thickness sensor 39 is a film thickness measuring instrument that measures the film thickness of the wafer W while moving across the surface of the wafer W with the rotation of the polishing table 12. As the film thickness sensor 39, a non-contact type sensor such as an eddy current sensor or an optical sensor can be used. The measured value of the film thickness is transmitted to the dressing monitoring device 35. The dressing monitoring device 35 is configured to generate a film thickness profile (film thickness distribution along the radial direction of the wafer W) of the wafer W from the measured value of the film thickness.

Next, swinging of the dresser 23 will be described with reference to FIG. 2. The dresser arm 26 turns clockwise and counterclockwise around a point J by a predetermined angle. The position of this point J corresponds to the center position of the support shaft 31 illustrated in FIG. 1. The turning of the dresser arm 26 causes the rotation center of the dresser 23 to swing in the radial direction of the polishing pad 11 in a range indicated by an arc L.

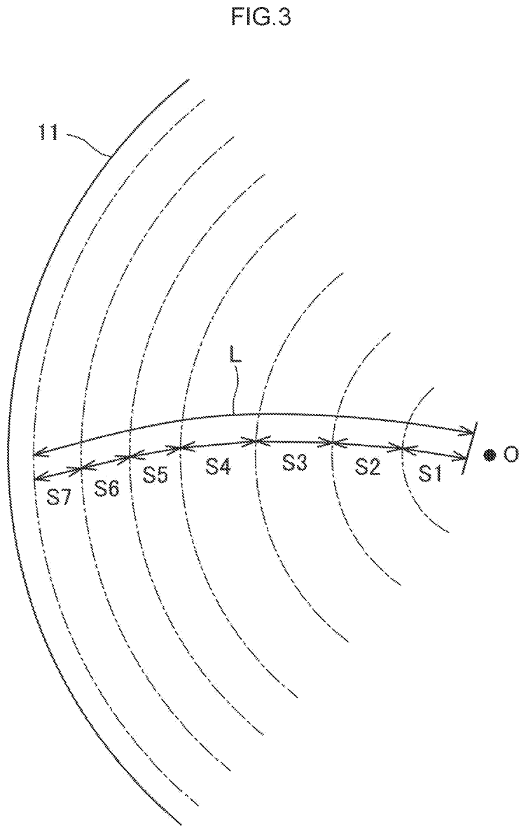

FIG. 3 is an enlarged view of the polishing surface 11a of the polishing pad 11. As illustrated in FIG. 3, the swinging range (swinging width L) of the dresser 23 is divided into a plurality of (seven in the example of FIG. 3) scanning areas (swinging sections) S1 to S7. The scanning areas S1 to S7 are virtual sections set in advance on the polishing surface 11a, and are arranged along a swinging direction of the dresser 23 (that is, the substantially radial direction of the polishing pad 11). The dresser 23 dresses the polishing pad 11 while moving across the scanning areas S1 to S7. The lengths of the scanning areas S1 to S7 may be equal to or different from each other.

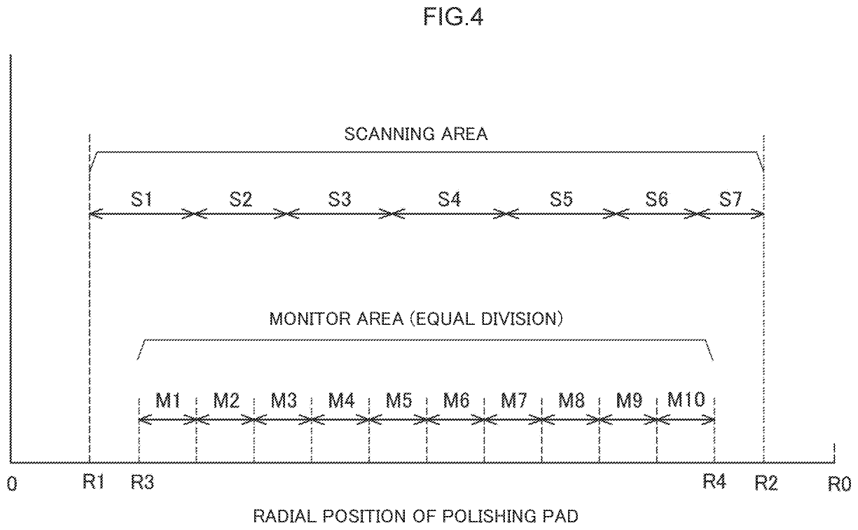

FIG. 4 is an explanatory view illustrating a positional relationship between the scanning areas S1 to S7 of the polishing pad 11 and monitoring areas M1 to M10. The horizontal axis of FIG. 4 represents a distance from the center of the polishing pad 11. In the present embodiment, a case where seven scanning areas and ten monitoring areas are set is taken as an example, but the number of scanning areas and the number of monitoring areas can be appropriately changed. In addition, it is difficult to control the pad profile in a region having a width corresponding to the radius of the dresser 23 from both ends of the scanning area. Thus, a monitor exclusion width is provided on the inner side (regions R1 to R3 in FIG. 4) and the outer side (regions R4 to R2 in FIG. 4), but the exclusion width is not necessarily provided. That is, the scanning area may be the same as the monitoring area.

The moving speed of the dresser 23 when swinging on the polishing pad 11 is set in advance for each of the scanning areas S1 to S7, and can be appropriately adjusted. The moving speed distribution of the dresser 23 represents the moving speed of the dresser 23 in each of the scanning areas S1 to S7.

The moving speed of the dresser 23 is one of determinants of the pad height profile of the polishing pad 11. The cutting rate of the polishing pad 11 represents the amount (thickness) of the polishing pad 11 scraped off by the dresser 23 per unit time. When the dresser is moved at a constant speed, normally, the thickness of the polishing pad 11 scraped off in each of the scanning areas is different, and thus the numerical value of the cutting rate is also different for each of the scanning areas. However, normally, it is preferable to maintain the initial shape of the pad profile, and thus the moving speed is adjusted so that the difference in the scraping amount for each of the scanning areas is reduced.

Here, increasing the moving speed of the dresser 23 means shortening the staying time of the dresser 23 on the polishing pad 11, that is, reducing the cutting amount of the polishing pad 11. On the other hand, decreasing the moving speed of the dresser 23 means lengthening the staying time of the dresser 23 on the polishing pad 11, that is, increasing the cutting amount of the polishing pad 11. Therefore, it is possible to reduce the scraping amount in a certain scanning area by increasing the moving speed of the dresser 23 in this scanning area, and it is possible to increase the scraping amount in a certain scanning area by decreasing the moving speed of the dresser 23 in this scanning area. As a result, it is possible to adjust the pad height profile of the entirety of the polishing pad.

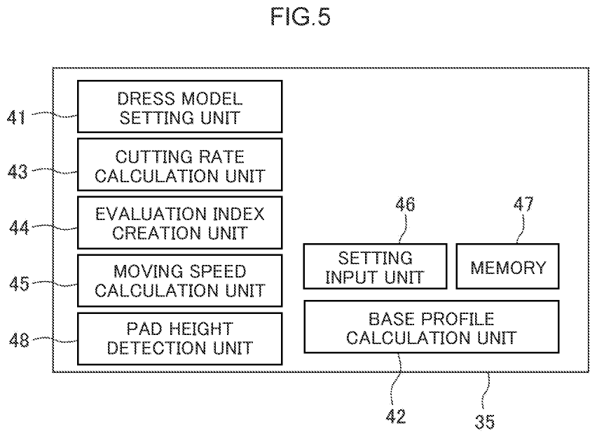

As illustrated in FIG. 5, the dressing monitoring device 35 includes a dress model setting unit 41, a base profile calculation unit 42, a cutting rate calculation unit 43, an evaluation index creation unit 44, a moving speed calculation unit 45, a setting input unit 46, a memory 47, and a pad height detection unit 48. The dressing monitoring device 35 acquires the profile of the polishing pad 11 and sets the moving speed of the dresser 23 in the scanning area to be optimal at a predetermined timing.

The dress model setting unit 41 sets a dress model S for calculating the polishing amount of the polishing pad 11 in the scanning area. The dress model S is a real number matrix of m rows and n columns when the number of divisions of the monitoring area is set as m (10 in the present embodiment) and the number of divisions of the scanning area is set as n (7 in the present embodiment). The dress model S is determined by various parameters described later. When the scanning area is the same as the monitoring area, the dress model S is S=[s₁, s₂, . . . , sₙ].

When the scanning speed of the dresser in each scanning area set in the polishing pad 11 is set to V=[v₁, v₂, . . . , vₙ] and the width of each scanning area is set to W=[w₁, w₂, . . . , wₙ], the staying time of (the center of) the dresser in each scanning area is represented by T=W/V=[w₁/v₁, w₂/v₂, . . . , wₙ/vₙ]. At this time, when the pad wear amount in each monitoring area is set to U=[u₁, u₂, . . . , uₘ], the pad wear amount U is calculated by performing the matrix operation of U=ST with the above-described dress model S and the staying time T in each scanning area.

In deriving the dress model matrix S, for example, elements of 1) a cutting rate model, 2) a dresser diameter, and 3) a scanning speed control can be appropriately combined in consideration. The cutting rate model is set on the assumption that each element of the dress model matrix S is proportional to the staying time in the monitoring area or proportional to a scratching distance (movement distance).

In addition, regarding the dresser diameter, each element of the dress model matrix S is set on the assumption that the diameter of the dresser is considered (the polishing pad is worn according to the same cutting rate over the entire effective area of the dresser) or not considered (the polishing pad is worn according to the cutting rate only at the center position of the dresser). In consideration of the dresser diameter, for example, an appropriate dress model can also be defined for a dresser onto which diamond grains are applied in a ring shape. Furthermore, regarding the scanning speed control, each element of the dress model matrix S is set according to whether the change in the moving speed of the dresser is stepwise or sloped. By appropriately combining the parameters, it is possible to calculate the cutting amount more matching with the actual state from the dress model S and obtain a correct profile prediction value.

The pad height detection unit 48 detects the pad height in each monitoring area by associating height data of the polishing pad, which is obtained by continuous measurement of the pad height sensor 32 with measurement coordinate data on the polishing pad.

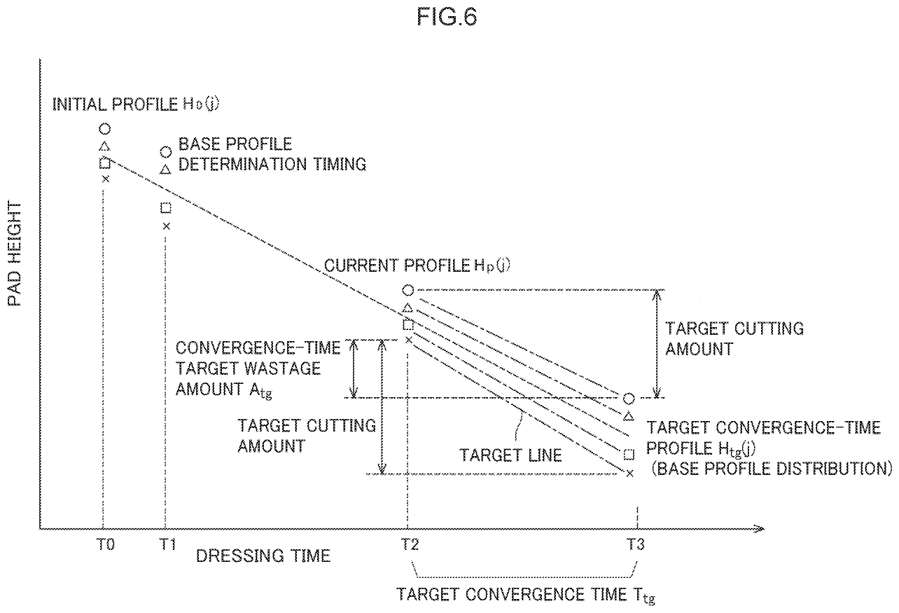

The base profile calculation unit 42 calculates a target profile (base profile) of the pad height at the time of convergence (see FIG. 6). The base profile is used to calculate a target cutting amount to be used by the moving speed calculation unit 45 described later. The base profile may be calculated based on the height distribution (Diff(j)) of the polishing pad in the pad initial state and the measured pad height, or may be given as a setting value. In addition, when the base profile is not set, the target cutting amount at which the shape of the polishing pad becomes flat may be calculated.

The base of the target cutting amount is calculated by the following expression using a pad height profile Hₚ(j) [j=1, 2, . . . , m] indicating the pad height in each monitoring area at the present time and a convergence-time target wastage amount A_{tg} separately set.

$$min \{ {H}_{p} ( j ) \} - {A}_{t g}$$

In addition, the target cutting amount in each monitoring area can be calculated by the following expression in consideration of the above-described base profile.

$$min \{ {H}_{p} ( j ) \} - {A}_{tg} + Diff ( j )$$

The cutting rate calculation unit 43 calculates the cutting rate of the dresser in each monitoring area. For example, the cutting rate may be calculated from the inclination of the change amount of the pad height in each monitoring area (the change amount of the pad height per unit time).

The evaluation index creation unit 44 optimizes the moving speed of the dresser in each scanning area by calculating and correcting the optimal staying time (swinging time) in the scanning area with an evaluation index described later. The evaluation index is an index based on 1) a deviation from the target cutting amount, 2) a deviation from the staying time in a reference recipe, and 3) a speed difference between adjacent scanning areas, and is a function of the staying time T=[w₁/v₁, w₂/v₂, . . . , wₙ/vₙ] in each scanning area. The moving speed of the dresser is optimized by determining the staying time T in each scanning area so that the evaluation index is minimized.

1) Deviation from Target Cutting Amount

When the target cutting amount of the dresser is set to U₀=[U₀₁, U₀₂, . . . , U₀ₘ], the deviation from the target cutting amount is calculated by obtaining a square value (|U−U₀|²) of a difference from the pad wear amount U (=ST) in each monitoring area described above. The target profile for determining the target cutting amount can be determined at any timing after the use of the polishing pad is started, or may be determined based on a manually set value.

2) Deviation from Staying Time in Reference Recipe

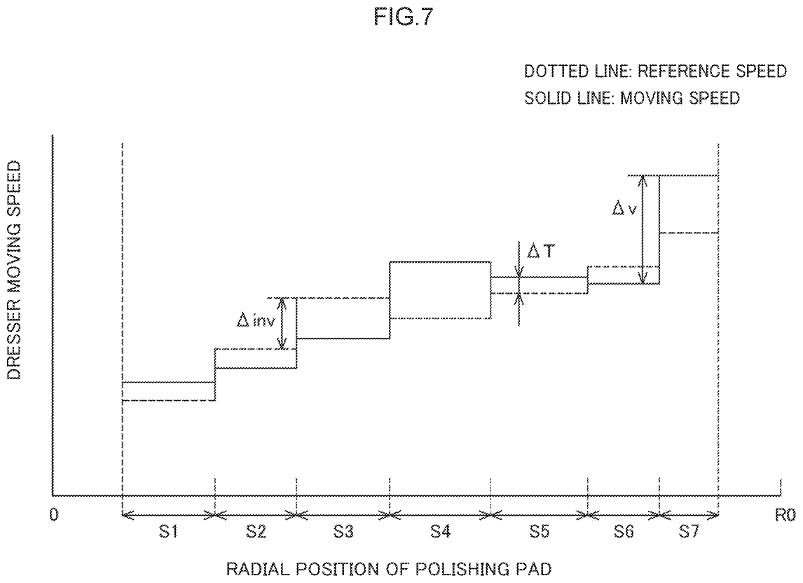

As illustrated in FIG. 7, the deviation from the staying time in the reference recipe can be calculated by obtaining a square value (ΔT²=|T−T₀|²) of a difference (ΔT) between the moving speed (reference speed (reference staying time T₀)) of the dresser based on the reference recipe set in each scanning area and the moving speed (staying time T of the dresser) of the dresser in each scanning area. Here, the reference speed is a moving speed at which a flat cutting rate is expected to be obtained in each scanning area, and is a value obtained in advance by experiment or simulation. When the reference speed is obtained by simulation, for example, the reference speed can be obtained on the assumption that the scratching distance (staying time) of the dresser and the cutting amount of the polishing pad are proportional to each other. The reference speed may be set to be appropriately updated according to the actual cutting rate during the use of the same polishing pad.

### 3) Speed Difference Between Adjacent Scanning Areas

The index of the speed difference between the adjacent scanning areas can be calculated by obtaining a square value (|ΔVᵢₙᵥ|²) of the speed difference between the adjacent scanning areas. Here, as illustrated in FIG. 7, either the difference (Δᵢₙᵥ) of the reference speed or the moving speed (Δᵥ) of the dresser can be applied as the speed difference between the scanning areas. Since the width of the scanning area is a fixed value, the index of the speed difference depends on the staying time of the dresser in each scanning area.

The evaluation index creation unit 44 defines an evaluation index J represented by the following expression based on the three indexes.

$$J = γ {\vert U - {U}_{0} \vert}^{2} + λ {\vert T - {T}_{0} \vert}^{2} + η {\vert Δ {V}_{inv} \vert}^{2}$$

Here, the first term, the second term, and the third term on the right side of the evaluation index J are indices caused by the deviation from the target cutting amount, the deviation from the staying time in the reference recipe, and the speed difference between adjacent scanning areas, respectively. All the first term, the second term, and the third term depend on the staying time T of the dresser in each scanning area.

The moving speed calculation unit 45 performs optimization calculation such that the value of the evaluation index J takes a minimum value, obtains the staying time T of the dresser in each scanning area, and corrects the moving speed of the dresser. As a method of the optimization calculation, a quadratic programming method can be used, but convergence calculation by simulation or PID control may be used.

In the evaluation index J, γ, λ, and n are predetermined weighting values (coefficients), and can be appropriately changed during the use of the same polishing pad. By changing the weighting values, it is possible to appropriately adjust an index to be emphasized according to the characteristics of the polishing pad and the dresser and the operation status of the device. The larger the weighting value (coefficient), the smaller the update amount of the moving speed of the dresser (the fluctuation of the moving speed of the dresser is suppressed).

When the moving speed of the dresser is obtained, it is preferable to set the total dressing time within a predetermined value. Here, the total dressing time is the movement time of the entire swinging section (the scanning areas S1 to S7 in the present embodiment) by the dresser. When the total dressing time (time required for dressing) becomes long, there is a possibility that other processes such as a polishing process and a conveyance process of the wafer are affected. Therefore, it is preferable to appropriately correct the moving speed in each scanning area so that this value does not exceed a predetermined value. In addition, since there are mechanical constraints of the device, it is preferable to set the moving speed of the dresser such that the maximum (and minimum) moving speed of the dresser and the ratio of the maximum speed (minimum speed) to the initial speed are also within set values.

When the appropriate dressing condition is unknown due to the combination of a new dresser and the polishing pad, or when the reference speed (reference staying time T₀) of the dresser is not determined as immediately after replacement of the dresser or the polishing pad, the moving speed calculation unit 45 may determine the evaluation index J (described below) by using only the condition of the deviation from the target cutting amount and optimize (initially set) the moving speed of the dresser in each scanning area.

$$J = {\vert U - {U}_{0} \vert}^{2}$$

The setting input unit 46 is an input device such as a keyboard or a mouse, for example, and inputs various parameters such as a value of each component of the dress model matrix S, setting of a constraint condition, a cutting rate update cycle, and a moving speed update cycle. The memory 47 stores various types of data such as data of a program for operating each component constituting the dressing monitoring device 35, a value of each component of the dress model matrix S, the target profile, the weighting value of the evaluation index J, and the setting value of the moving speed of the dresser.

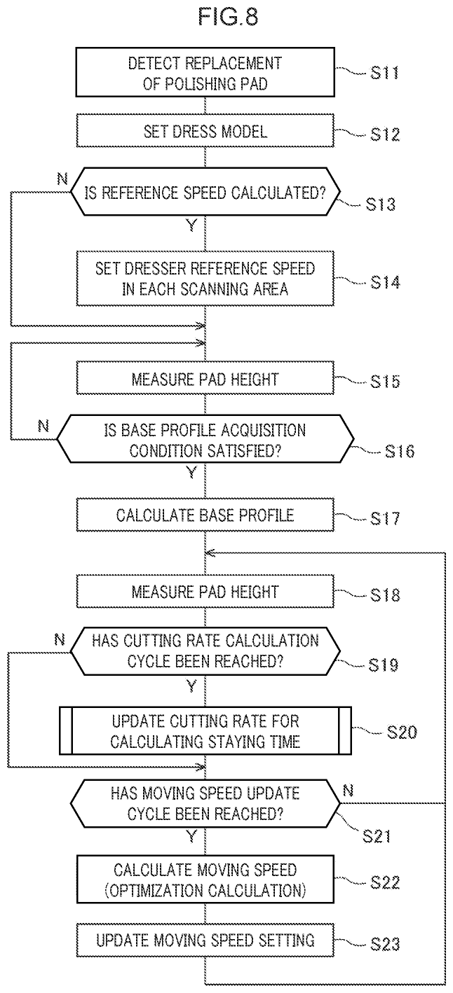

FIG. 8 is a flowchart illustrating a processing procedure for controlling the moving speed of the dresser. When it is detected that the polishing pad 11 has been replaced (Step S11), the dress model setting unit 41 derives the dress model matrix S in consideration of the parameters of the cutting rate model, the dresser diameter, and the scan speed control (Step S12). In the case of the same type of pad, the dress model matrix can be continuously used.

Then, it is determined whether or not to calculate the reference speed of the dresser (whether or not the setting input unit 46 has made an input to perform the reference speed calculation) (Step S13). When the reference speed is calculated, the moving speed calculation unit 45 sets the moving speed (staying time T) of the dresser in each scanning area such that the next evaluation index J takes the minimum value from the target cutting amount U₀ of the dresser and the pad wear amount U in each monitoring area (Step S14). The calculated reference speed may be set as an initial value of the moving speed.

$$J = {\vert U - {U}_{0} \vert}^{2}$$

Thereafter, when a dressing process is performed on the polishing pad 11 along with a polishing process of the wafer W, the height (pad height) of the polishing surface 11a is measured by the pad height sensor 32 (Step S15). Then, it is determined whether or not a condition for acquiring a base profile (for example, polishing of a predetermined number of wafers W) is satisfied (Step S16). When the condition is satisfied, the base profile calculation unit 42 calculates a target profile (base profile) of the pad height at the time of convergence (Step S17).

Thereafter, when a dressing process is performed on the polishing pad 11 along with a polishing process of the wafer W, the height (pad height) of the polishing surface 11a is also measured by the pad height sensor 32 (Step S18). Then, it is determined whether or not a predetermined cutting rate calculation cycle (for example, polishing of a predetermined number of wafers W) has been reached (Step S19). When the predetermined cutting rate calculation cycle has been reached, the cutting rate calculation unit 43 calculates the cutting rate of the dresser in each scanning area (Step S20).

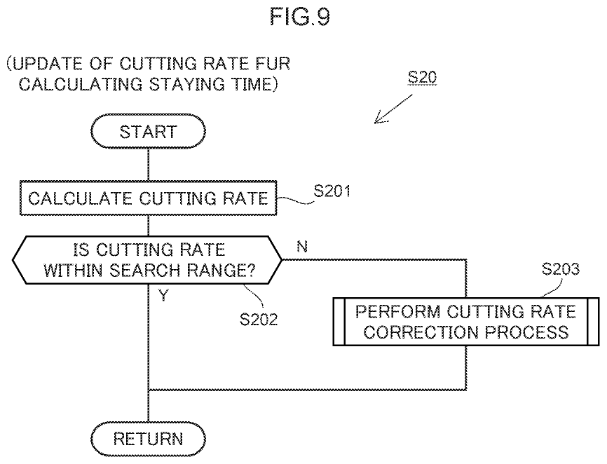

FIG. 9 is a diagram illustrating an example of processing of updating a cutting rate for calculating the staying time in Step S20. As illustrated in FIG. 9, first, the cutting rate calculation unit 43 calculates the cutting rate from the inclination of the change amount of the pad height in each monitoring area (the change amount of the pad height per unit time) (Step S201). Then, the cutting rate calculation unit 43 determines whether or not the calculated cutting rate is within a search range for tracking the cutting rate (Step S202). Here, the search range is a range of a predetermined amount based on an initial cutting rate set in advance in an initializing process such as replacement of the polishing pad. For example, a range of a cutting rate of +0.05% around the initial cutting rate is set as the search range. When the determination is negated, the cutting rate calculation unit 43 performs a cutting rate correction process (Step S203). On the other hand, when the determination is affirmed, the process returns to the main processing flow without performing the cutting rate correction process.

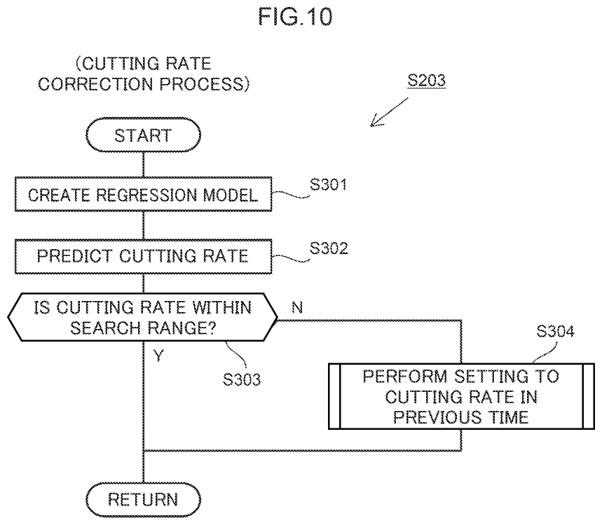

FIG. 10 is a flowchart illustrating an example of the cutting rate correction process in Step S203 (when the calculated cutting rate falls outside the search range). As illustrated in FIG. 10, the cutting rate calculation unit 43 creates a regression model (regression equation) for predicting the cutting rate by using predetermined data points including the cutting rate calculated in Step S201 (Step S301).

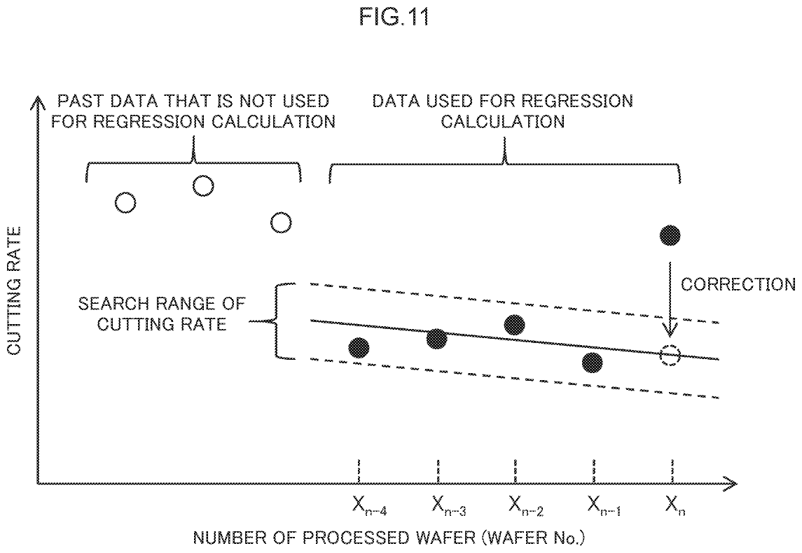

FIG. 11 is a graph illustrating a relationship between the number of processed wafers and the cutting rate, and is a view for describing correction of the cutting rate. As illustrated in FIG. 11, when the cutting rate calculated for the Xₙth wafer W falls outside the search range, the cutting rate calculation unit 43 creates a regression model (regression equation) by using, for example, data (Xₙ₋₄ to Xₙ) of past five points including the Xₙth wafer W. The regression model may be any model other than a linear regression model.

Returning to FIG. 10, the cutting rate calculation unit 43 predicts the cutting rate (in the example of FIG. 11, the cutting rate of the Xₙth wafer W) based on the created regression model (Step S302). Then, it is determined whether or not the predicted cutting rate is within the search range (Step S303). When this determination is affirmed, the cutting rate correction process is ended, and the process returns to the main processing flow (FIG. 8). On the other hand, when the determination is negated (when the predicted cutting rate is out of the search range), the predicted cutting rate is discarded, and the cutting rate in the previous time (Xₙ₋₄th wafer W) is set as the cutting rate in this time (Xₙth wafer W) (Step S304).

As described above, in the present embodiment, since control (tracking) is performed such that the cutting rate falls within the predetermined range, it is possible to appropriately calculate the cutting rate even when the height of the polishing pad fluctuates due to swelling.

Returning to FIG. 8, it is determined whether or not the moving speed update cycle (for example, polishing of a predetermined number of wafers W) of the dresser has been reached (Step S21). When the moving speed update cycle has been reached, the moving speed calculation unit 45 calculates the staying time of the dresser in which the evaluation index J is minimized, thereby optimizing the dresser moving speed in each scanning area (Step S22). Then, the value of the optimized moving speed is set, and the moving speed of the dresser is updated (Step S23). Thereafter, the process returns to Step S18, and the above processes are repeated until the polishing pad 11 is replaced.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A substrate polishing device comprising:
a height detection unit configured to measure a surface height of a polishing member; and
a cutting rate calculation unit configured to calculate a cutting rate of the polishing member based on the surface height, wherein
the cutting rate calculation unit corrects the current cutting rate based on the cutting rate calculated in the past when the calculated current cutting rate falls outside a search range.

2. The substrate polishing device according to claim 1, wherein the cutting rate calculation unit predicts a cutting rate by a regression model created based on the cutting rate calculated in the past, and corrects the current cutting rate by using the predicted cutting rate.

3. The substrate polishing device according to claim 2, wherein the cutting rate calculation unit replaces the current cutting rate with a previous cutting rate when the current cutting rate corrected by the regression model falls outside the search range.

4. The substrate polishing device according to claim 2, wherein the regression model is created based on the cutting rate calculated in the past and the current cutting rate.

5. The substrate polishing device according to claim 1, wherein the search range is a range based on a cutting rate set in advance.

6. The substrate polishing device according to claim 1, wherein a height profile of the polishing member is estimated based on the cutting rate calculated by the cutting rate calculation unit.

7. A substrate processing apparatus comprising: the substrate polishing device according to claim 1.

8. A method comprising:
detecting a height for measuring a surface height of a polishing member; and
calculating a cutting rate of the polishing member based on the surface height,
wherein the calculating corrects the current cutting rate based on the cutting rate calculated in the past when the calculated current cutting rate falls outside a search range.

9. A non-transitory computer-readable storage medium storing a program for causing a computer to execute a method comprising:
detecting a height for measuring a surface height of a polishing member; and
calculating a cutting rate of the polishing member based on the surface height,
wherein the calculating corrects the current cutting rate based on the cutting rate calculated in the past when the calculated current cutting rate falls outside a search range.
